(19) United States
(12) Patent Application Publication
(10) Pub. No.: US 2008/0062562 A1
(43) Pub. Date: Mar. 13, 2008

(54) Information processing apparatus and write control method and program

(75) Inventors: Yoshihiro Kaneko, Fussa-shi (JP); Yoji Nagao, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/896,868

(22) Filed: Sep. 6, 2007

(30) Foreign Application Priority Data
Sep. 7, 2006 (JP) 2006-243113

(51) Int. Cl. G11B 5/82

(52) U.S. Cl. 360/135

(57) ABSTRACT

According to one embodiment, an information processing apparatus includes a disk drive capable of writing data to a disk on which data can be written, a storage device configured to store data to be written on the disk, priority setting unit for setting priorities of the data stored in the storage device in a case of writing the data on the disk, and writing unit for writing the data stored in the storage device, with the higher priorities set by the priority setting unit, on an outer periphery of the disk.

### CROSS-REFERENCE TO RELATED APPLICATIONS

This application is based upon and claims the benefit of priority from Japanese Patent Application No. 2006-243113, filed Sep. 7, 2006, the entire contents of which are incorporated herein by reference.

### BACKGROUND

1. Field

One embodiment of the invention relates to the present invention relates to an information processing apparatus and a write control method, capable of forming a disk wherein data items are written such that data items of higher priority are arranged on an outer periphery of a disk to make an access speed of the data of higher priority higher.

2. Description of the Related Art

In general, when data is written in a recordable optical disk, arrangement of the data on the optical disk after writing is innovated to reduce a seek distance of pickup upon reading the optical disk. As disclosed in, for example, JP-A No. 7-6367 (KOKAI), data items to be written on CD-ROM are configured such that to improve an access speed of CD-ROM, an access frequency of data recorded on a CD-ROM is measured, the data item of the highest access frequency based on a statistic value of the access frequency is allocated in a middle (hot spot) of a CD-ROM recording area and the data items of the second or further access frequencies are allocated at the front and rear sides of the hot spot. The seek time can be thereby reduced.

According to this technology, the seek time is reduced but a data read time cannot be reduced.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an outer appearance of an information processing apparatus according to an embodiment of the present invention;

FIG. 2 is an exemplary block diagram showing functions according to an embodiment of the present invention;

FIG. 3 is an exemplary flowchart showing a write control method to which the information processing apparatus of the present invention is applied;

FIG. 4 is an exemplary flowchart showing a write control method to which the information processing apparatus of the present invention is applied;

FIG. 5 is an exemplary illustration showing correspondence of written files to write priorities; and

FIG. 6 is an exemplary illustration showing arrangement of files written on the basis of the write priorities.

### DETAILED DESCRIPTION

Various embodiments according to the invention will be described hereinafter with reference to the accompanying drawings. In general, according to one embodiment of the invention, an information processing apparatus includes a disk drive capable of writing data to a disk on which data can be written, a storage device configured to store data to be written on the disk, priority setting unit for setting priorities of the data stored in the storage device in a case of writing the data on the disk, and writing unit for writing the data stored in the storage device, with the higher priorities set by the priority setting unit, on an outer periphery of the disk.

An embodiment of the present invention will be described below with reference to the accompanying drawings.

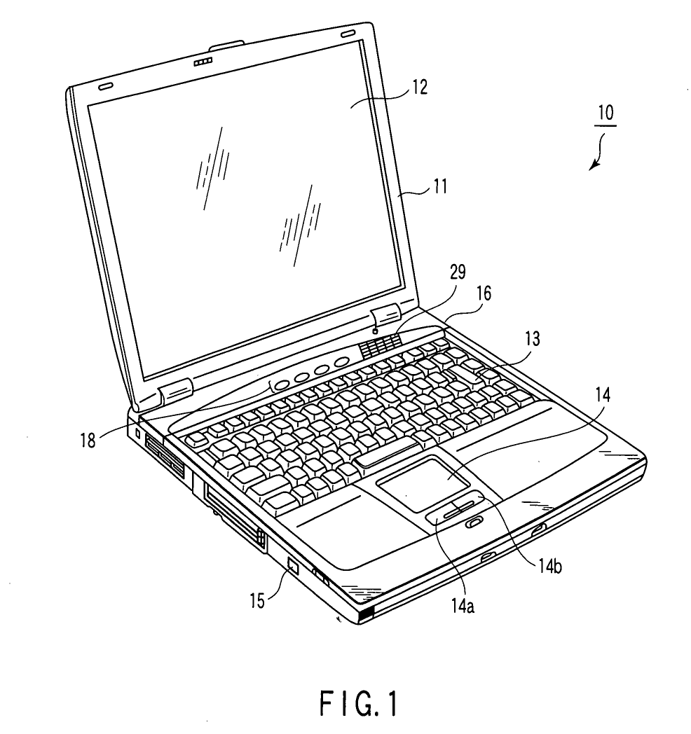

FIG. 1 is a perspective view showing an information processing apparatus according to the embodiment of the present invention. The information processing apparatus is implemented as a battery-operated notebook computer 10. The present invention is configured to write data of higher priority on an outer periphery of a writable optical disk and increase the speed of access to the data of higher priority.

The computer 10 is composed of a main body 16 and a display unit 11 as shown in FIG. 1. A display device composed of an LCD (Liquid Crystal Display) is embedded in the display unit 11. A display screen 12 of the LCD is located approximately at the center of the display unit 11.

The display unit 11 is attached to the computer 10 so as to freely pivot between an opened position and a closed position. The main body of the computer 10 has a housing shaped in a thin box, and comprises a keyboard 13 on a top face thereof, a touch pad 14, two buttons 14a, 14b, various kinds of shortcut buttons for mail and the like, a power button, a volume control button 18, a speaker 29 and the like on a palm rest thereof. A drive for writable disk 15 and the like are provided on a side face of the main body 16. In the present embodiment, an optical disk is explained as a disk capable of writing data. However, if a read speed of data on an outer periphery of the disk is different from a read speed of data on an inner periphery, the present invention can be applied to a disk-shaped recording medium other than the optical disk.

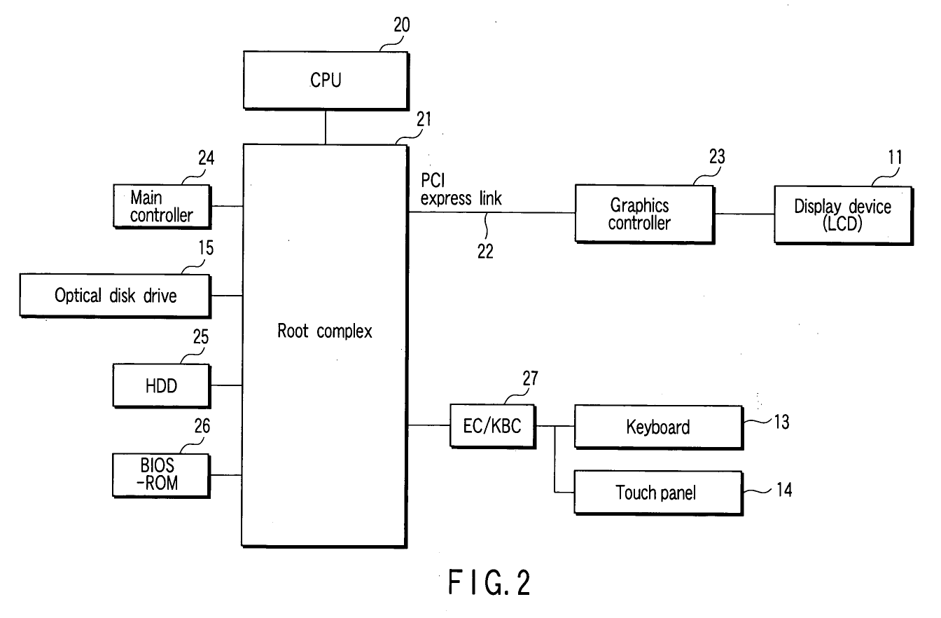

FIG. 2 is a block diagram showing main components of the information processing apparatus according to the first embodiment.

The computer 10 comprises a CPU (Central Processing Unit) 20, a Root Complex 21, a main memory 24, a graphics controller (End Point) 23, a PCI Express Link 22 making a connection between the Root Complex (chip set) 21 and the graphics controller 23, the display unit 1l serving as a display unit (LCD), an embedded controller/keyboard controller IC (EC/KBC) 27, a hard disk drive (HDD) 25, a BIOS-ROM 26, a keyboard 13 and touch pad 14 and the like.

The Root Complex 21, the graphics controller 23, and the like are devices which are in conformity with the PCI EXPRESS standards. The communications between the Root Complex 21 and the graphics controller 23 are executed over the PCI Express Link 22 arranged between the Root Complex 21 and the graphics controller 23.

The CPU 20 is a processor configured to control the operations of the computer 10, and executes various kinds of programs (operating system and application systems) loaded on the main memory 24 by the HDD 25. In addition, the CPU 20 also executes the BIOS (Basic Input Output System) stored in the BIOS-ROM 26. The BIOS is a program for controlling the hardware.

The Root Complex 21 is a bridge device making a connection between a local bus of the CPU 20 and the graphics controller 23. In addition, the Root Complex 21 also has a function of executing communications with the graphics controller 23 over the PCI Express Link 22.

The graphics controller 23 is a display controller configured to control the display unit 11 employed as a display monitor of the computer.

The EC/KBC 27 is a one-chip microcomputer on which an embedded controller for power management and a keyboard controller controlling the keyboard 13 and the touch pad 14 are integrated. The EC/KBC 27 has a function of controlling power-on/power-off of the computer 10, in cooperation with a power supply controller, in response to the user's operation of the power button.

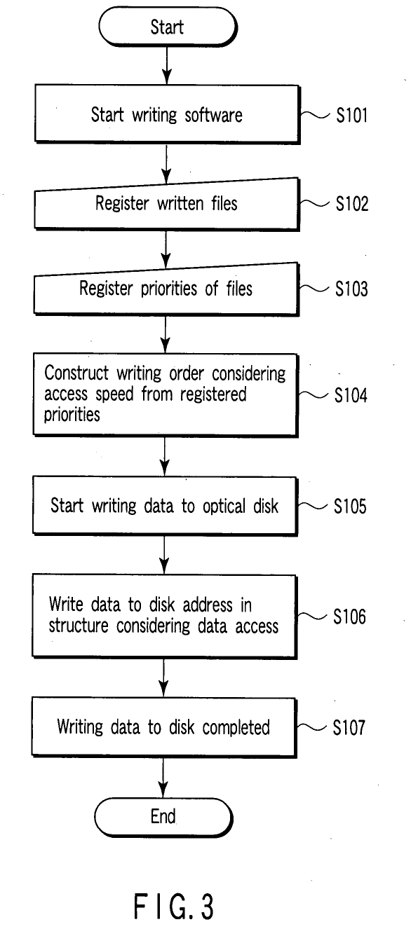

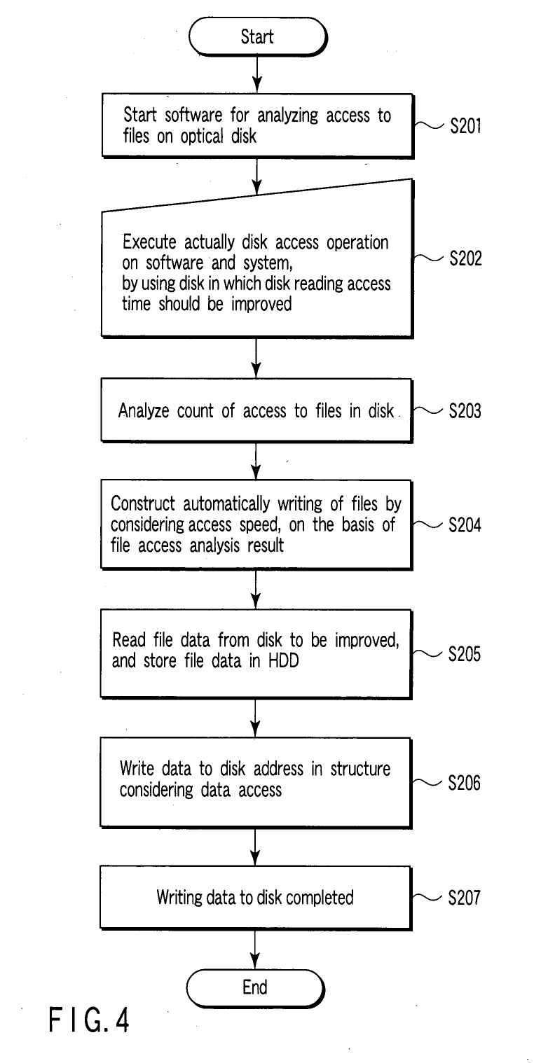

Next, a write control method to which the information processing apparatus of the present invention is applied will be described with reference to flowcharts of FIG. 3 and FIG. 4.

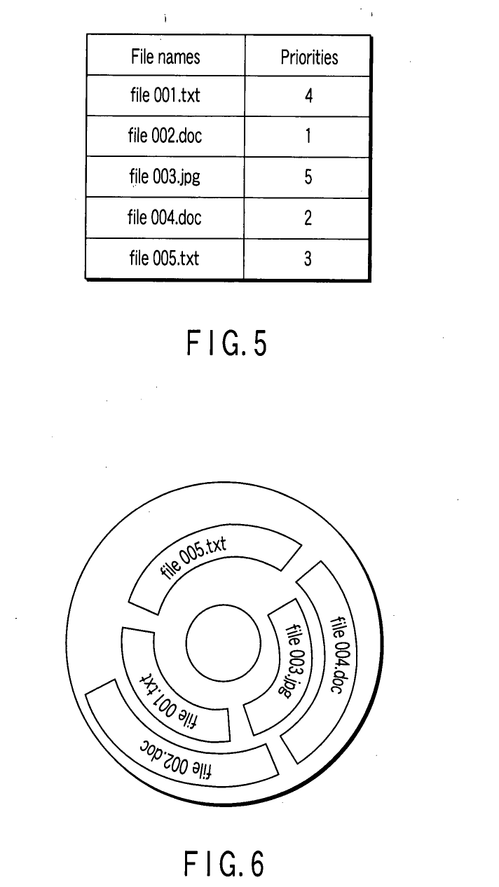

First, when a writing software application for writing data on an optical disk is started by the CPU 20 on the operation system (block S101), written files are registered on the writing software application (block S102). Next, priorities of the written files are registered (block S103). The registration of the priorities of the written files may be executed by the user or the writing software application. At the registration of the priorities, the following manner of setting the priorities can be conceived: an order of the files which are required access speed, an order of dates of the files (ascending order/descending order), an order of names of the files (ascending order/descending order), an order of extensions of the files (an order of names of character strings of extensions), and an order of file sizes (ascending order/descending order). For example, the order of priorities of the written files is registered as shown in FIG. 5.

On the basis of the registered order of priorities of the written files, the writing order is constructed by the CPU 20 by considering the speed for accessing the disk (block S104). For example, the written files of higher priorities are constructed so as to be written on the outer periphery of the disk. For example, in FIG. 5, an optical disk is formed such that the files are written in the order of file003.jpg (priority 5), file001.txt (priority 4), file005.txt (priority 3), file004.doc (priority 2), and file002.doc (priority 1), from the inner periphery to the outer periphery (cf. FIG. 6). The CPU 20 starts writing the data to the optical disk (block S105), writes the files on the basis of the constructed writing order (block S106), and ends writing the data to the optical disk (block S107).

As for the file names, an order of file names employed in the general operation system (for example, alphabetical order, numerical order, etc.) may be employed.

Next, FIG. 4 is a flowchart showing a process of determining the priorities of the file data on the optical disk in order of higher access frequency. The disk access count is analyzed, the access frequency is preliminarily measured, and the access frequency is determined on the access count.

When an access analysis software application for analyzing access to the data on an optical disk is started by the CPU 20 on the operation system (block S201), an optical disk whose read time should be improved is set in the drive, an application or the like to be used actually is operated (block S202), and analysis of access to the optical disk is executed (block S203). In this analysis of access, the access count of the files on the optical disk accessed by the application to be used actually is measured.

The CPU 20 automatically constructs writing the files by considering the speed of access to the optical disk, on the basis of the access analysis result (block S204). For example, priorities are given to the files such that the files having more access counts are arranged on the outer periphery. The files on the optical disk whose access analysis has been analyzed are copied to the HDD 25 or the like (block S205). The copied files are written on the optical disk in the order of priorities (block S206). When the writing is completed, the optical disk on which the files of higher access frequency are arranged on the outer periphery is completed (block S207).

According to the present embodiment, the seek time can be reduced at the access to the data recorded on the disk such as the optical disk or the like, and the time required to read the data can also be reduced.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a disk drive capable of writing data to a disk on which data can be written;
a storage device configured to store data to be written on the disk;
priority setting unit for setting priorities of the data stored in the storage device in a case of writing the data on the disk; and
writing unit for writing the data stored in the storage device, with the higher priorities set by the priority setting unit, on an outer periphery of the disk.

2. The apparatus according to claim 1, wherein the priority setting unit assigns higher priorities to the data required higher access speeds.

3. The apparatus according to claim 1, wherein the priority setting unit obtains a frequency of access to the data stored in the storage device and assigns higher priorities to the data of higher frequencies.

4. The apparatus according to claim 1, wherein the priority setting unit assigns higher priorities to the data in order of dates of the data.

5. The apparatus according to claim 1, wherein the priority setting unit assigns higher priorities to the data in order of file names of the data.

6. The apparatus according to claim 1, wherein the priority setting unit assigns higher priorities to the data in order of sizes of the data.

7. A write control method of controlling a disk drive capable of writing data to a disk on which data can be written, comprising;
storing data to be written on the disk;
setting priorities of the data stored in the storage device in a case of writing the data on the disk; and
writing the data stored in the storage device, with the higher priorities set by the priority setting unit, on an outer periphery of the disk.

8. The method according to claim 7, wherein setting the priorities assigns higher priorities to the data required higher access speeds.

9. The method according to claim 7, wherein setting the priorities obtains a frequency of access to the data stored in the storage device and assigns higher priorities to the data of higher frequencies.

10. A computer-executable write control program for controlling writing data to a disk on which data can be written, comprising;
storing data to be written on a disk drive in a storage device;
setting priorities of the data stored in the storage device in a case of writing the data on the disk; and
writing the data stored in the storage device, with the higher priorities set by the priority setting unit, on an outer periphery of the disk.
